(19) United States
(12) Patent Application Publication
(10) Pub. No.: US 2025/0139051 A1
(43) Pub. Date: May 1, 2025

(54) GLOBALS BLOCKS IN REPLICATED BLOCK ARRAYS

(71) Applicant: Tesla, Inc., Austin, TX (US)

(72) Inventors: Timothy Fischer, Denver, CO (US); Anantha Kumar Nivarti, Fremont, CA (US); Derek Carson, San Jose, CA (US)

(21) Appl. No.: 18/683,636

(22) PCT Filed: Aug. 11, 2022
(86) PCT No.: PCT/US2022/040085

§ 371 Date: Feb. 14, 2024

Related U.S. Application Data
(60) Provisional application No. 63/235,011, filed on Aug. 19, 2021.
(60) Provisional application No. 63/303,844, filed on Jan. 27, 2022.

(51) Int. Cl. G06F 15/78; G06F 11/30

(52) U.S. Cl. CPC G06F 15/7803; G06F 11/3058

(57) ABSTRACT

Systems and methods for efficient replicated block arrays are disclosed. In some embodiments, a computing system can include a plurality of functional blocks, wherein each of the plurality of functional blocks is an instance of a computing circuitry block, and a globals block having a same footprint as an individual one of the functional blocks, the globals block comprising circuitry that is different than the functional block, wherein the plurality of functional blocks and the globals block are included in an array.

### CROSS-REFERENCE TO RELATED APPLICATIONS

This application claims the benefit of U.S. Provisional Application No. 63/235,011, filed Aug. 19, 2021, titled “GLOBALS BLOCKS AS WAY TO AVOID SPLITTING A HIGHLY-REPLICATED BLOCK ARRAY,” and U.S. Provisional Application No. 63/303,844, filed Jan. 27, 2022, titled “GLOBALS BLOCKS IN REPLICATED BLOCK ARRAYS,” the disclosures of which are incorporated herein by reference in their entireties and for all purposes.

### BACKGROUND

### Technical Field

The present disclosure relates generally to electronic assemblies, computing systems, and related methods.

### Description of the Related Art

High performance computing systems are important for many applications. However, conventional designs often use space inefficiently, leading to decreases in computing density, increased power consumption, and decreased performance.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

In some aspects, the techniques described herein relate to a computing system including: a plurality of functional blocks, wherein each of the plurality of functional blocks is an instance of a computing circuitry block; and a globals block having a same footprint as an individual one of the functional blocks, the globals block including circuitry that is different than the functional block, wherein the plurality of functional blocks and the globals block are included in an array.

In some aspects, the techniques described herein relate to a computing system, wherein the array includes a plurality of globals blocks, and the globals blocks include the globals block.

In some aspects, the techniques described herein relate to a computing system, wherein the plurality of globals blocks are distributed periodically in the array.

In some aspects, the techniques described herein relate to a computing system, wherein the array includes more functional blocks than globals blocks.

In some aspects, the techniques described herein relate to a computing system, wherein the globals blocks are fewer than 5% of a total number of the functional and globals blocks of the array.

In some aspects, the techniques described herein relate to a computing system, wherein the globals block includes a sensor.

In some aspects, the techniques described herein relate to a computing system, wherein the sensor is configured to sense at least one of temperature or voltage.

In some aspects, the techniques described herein relate to a computing system, wherein the globals block is configured to provide an interrupt to at least one of the plurality of functional blocks.

In some aspects, the techniques described herein relate to a computing system, wherein the globals block has a same interface as an individual functional block of the plurality of functional blocks.

In some aspects, the techniques described herein relate to a computing system, wherein the globals block is electrically connected to at least two of the plurality of functional blocks.

In some aspects, the techniques described herein relate to a computing system, wherein the globals block is configured to provide a dynamic frequency scaling signal to at least one functional block of the plurality of functional blocks.

In some aspects, the techniques described herein relate to a computing system, wherein the globals block includes a mask alignment target.

In some aspects, the techniques described herein relate to a computing system, wherein the globals block includes clock generation and distribution circuitry.

In some aspects, the techniques described herein relate to a computing system, wherein the globals block includes debug circuitry.

In some aspects, the techniques described herein relate to a computing system, wherein the globals block includes non-volatile memory.

In some aspects, the techniques described herein relate to a computing system, wherein the globals block includes input/output circuitry, and the input/output circuitry is configured to communicate with circuitry that is outside the array.

In some aspects, the techniques described herein relate to a computing system, wherein each of the functional blocks of the plurality of functional blocks includes an interface along each edge and computing circuitry.

In some aspects, the techniques described herein relate to a computing system, wherein each of the plurality of functional blocks is electrically connected to at least two adjacent functional blocks of the plurality of functional blocks.

In some aspects, the techniques described herein relate to a computing system, wherein a system on a wafer includes the array.

In some aspects, the techniques described herein relate to a computing system, wherein the computing system is configured to perform neural network training.

In some aspects, the techniques described herein relate to a method of operating a computing system, the method including: measuring, by a globals block, a parameter; generating, by the globals block, a signal based on the parameter; and providing, by the globals block, the signal to a functional block of a plurality of functional blocks, wherein the globals block and the plurality of functional blocks are in an array, and wherein the globals block includes circuitry that is different than the functional block.

In some aspects, the techniques described herein relate to a method, wherein the parameter is temperature or an indication of temperature, and wherein the signal includes a dynamic frequency scaling signal.

In some aspects, the techniques described herein relate to a method, wherein the parameter is provided by clock generation circuitry, and wherein the signal is a clock signal.

In some aspects, the techniques described herein relate to a method, further including providing the signal to a second functional block of the plurality of functional blocks.

In some aspects, the techniques described herein relate to a computing system including: a plurality of functional blocks, wherein each of the plurality of functionals blocks includes an instance of a computing circuitry element; and a globals block having a same footprint as an individual one of the functional blocks, the globals block including circuitry that is different than the functional block, wherein the plurality of functional blocks and the globals block are included in an array, wherein the globals block has a same interface as the individual one of the functional blocks, and wherein the globals block includes a sensor configured to sense at least one of temperature or voltage.

### BRIEF DESCRIPTION OF THE DRAWINGS

This disclosure is described herein with reference to drawings of certain embodiments, which are intended to illustrate, but not to limit, the present disclosure. It is to be understood that the accompanying drawings, which are incorporated into and constitute a part of this specification, and for the purpose of illustrating concepts disclosed herein and may not be to scale.

FIG. 1A depicts a block array of replicated blocks.

FIG. 1B depicts a block array with replicated blocks with a channel.

FIG. 2 depicts a block array with replicated blocks and globals blocks according to embodiments.

FIG. 3 depicts a schematic block diagram of an illustrative globals block.

FIG. 4A is a schematic block diagram of an example functional block according to an embodiment.

FIG. 4B is a schematic block diagram of an example globals block according to an embodiment.

### DETAILED DESCRIPTION OF CERTAIN EMBODIMENTS

The following description of certain embodiments presents various descriptions of specific embodiments. However, the innovations described herein may be embodied in a multitude of different ways, for example, as defined and covered by the claims. In this description, reference is made to the drawings where like reference numerals may indicate identical or functionally similar elements. It will be understood that elements illustrated in the figures are not necessarily drawn to scale. Moreover, it will be understood that certain embodiments may include more elements than illustrated in a drawing and/or a subset of the elements illustrated in a drawing. Further, some embodiments may incorporate any suitable combination of features from two or more drawings.

Block arrays are often used in computing applications to achieve high compute density. This may be advantageous, for example, when a large amount of computing power is desired, when there are space constraints, the like, or any suitable combination thereof. For example, such a system can be used to perform processing for neural network training or inference, as an autopilot system for a vehicle, to provide advanced driving assistance system functionality, or for other autonomous vehicle functionality. Dense computing systems may also be used in, for example, artificial intelligence or machine learning applications, high-performance computing applications, complex simulations, and other applications with large processing power demands. As one example, a computing system that is dense and high powered can generate autopilot data for a vehicle.

Block arrays offer several advantages in high-density computing, allowing more computing power to be contained within a smaller space relative to if separate chips were used to achieve similar computing power. Block arrays can offer higher performance where interface bandwidth is a limiting factor in certain applications. However, traditional block arrays have several drawbacks, including design complexities and inefficient use of area due to some circuit elements being repeated in each block of a block array.

Aspects of this disclosure relate to saving space within an array that includes a plurality of blocks that are each an instance of a computing circuitry block. The plurality of blocks can be referred to as functional blocks. A globals block can include significant but less-used circuit elements than the functional blocks. The globals block can include features of the functional blocks, such as interfacing features, but can be implemented without certain computing features that are present in the functional blocks. The globals block can include different functionality that is not implemented by the functional blocks. The globals block can include the same interfaces and communications on its edges as a functional block so that it can be swapped in place of a functional block in the array. The globals block can have a same footprint (e.g., width and length) as a functional block. The globals block can be included as desired in the block array. A block array can contain one globals block or multiple globals blocks. There can be significantly more functional blocks than globals blocks in the block array.

Often, some circuit elements are desired for proper functionality of the computing blocks in a block array, but they are sparingly or less frequently used than the replicated functional block of the block array. For example, it may be desirable to have sensors for temperature, voltage, process, one or more other parameters, or any suitable combination thereof. At the same time, there may be little or no advantage to having the same sensors in each block. In addition, mask alignment targets, clock generation circuitry, which may include an oscillator, phased-locked loops, delay-locked loops, and/or distribution circuitry, non-volatile storage such as efuses or one-time programmable memory, input/output circuitry, and debug circuitry may be desired for proper functionality of blocks in the array, but they may be used less frequently than other elements of compute blocks, and/or can be shared among a plurality of compute blocks.

In some cases, each block may have the same sparingly-used circuit elements, which may limit computing density. This may result in computing systems that are physically larger, have reduced computing power, have higher cooling requirements, consume more power, and/or cost more to manufacture.

Rather than including the same functionality in every block, gaps can be created between blocks or groups of blocks, creating “channels” or “grout.” Typically, channels run the entire width or length of block arrays and enable communication between blocks in the array. Sparingly-used elements can be placed within the channels instead of taking up space in each block. Channels offer flexibility in the placement of circuit elements within them as well as flexibility in routing to and from the circuit elements within them. However, channels can have significant limitations and drawbacks. For example, channels can take up a significant area on a chip, which can reduce computing density. In some cases, channels may be thin compared to the dimensions of an array block but may have limited ability to carry signals for network-on-chip (NoC) technology, clocks, and/or other signal transmission. In some cases, multiple thin channels may be desired for sensing or for higher throughput. Thin channels may be problematic for large arrays where signals are transmitted over large distances, as thin channels may not be sufficiently large to accommodate repeaters. In some applications, the limitations of thin channels can be overcome by making the channels larger or by using multiple thin channels. However, both of these options increase the surface area consumed by the channels, which reduces computing density.

The use of channels can also create discontinuities in communication between blocks. For example, in some cases signals are routed around a channel or take a less efficient path from one block to another, adding design complexities and compromises and potentially increasing costs. In some cases, discontinuities may result in the overdesign of a block or the breaking up of a single block into multiple cells (e.g., smaller blocks).

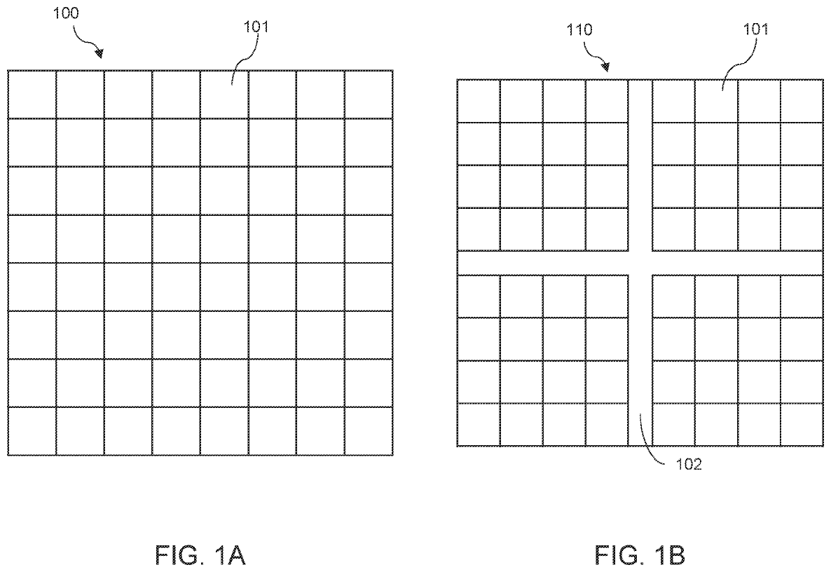

FIGS. 1A and 1B depict the block arrays. In FIG. 1A, an array 100 includes blocks 101. As shown in FIG. 1A, there are no functional elements other than the blocks 101. Thus, the blocks 101 may each contain all functionality, including sparingly-used elements, which may cause the blocks 101 to be larger than if some elements were removed from the blocks and instead only included in a subset of blocks of an array.

FIG. 1B shows an array 110 with blocks 101 and channel 102. In FIG. 1B, the blocks 101 may be made smaller by removing some elements from the blocks 101. Elements that are less commonly used and/or that may be shared among more than one the blocks 101 can be included in the channel 102. For example, the channel 102 can include a temperature sensor, a voltage monitor, a process monitor, sensing circuitry for one or more other parameters, the like, or any suitable combination thereof. For example, a process monitor can include circuitry with speed and/or another performance characteristic that varies with variations in the manufacturing process. In some embodiments, by measuring and reporting the speed and/or other characteristics of the process monitor circuitry, the process monitor can be used to estimate how the variation can affect other similar circuits. In some cases, variation can be systematic, and a process monitor can help project the relative speed of a device and/or other performance metrics, which may help to understand power components in a device and tune operation. Other sensors can also be included, such as aging sensors, supply noise sensors, physical security sensors, the like, or any suitable combination thereof.

In some embodiments, instead of using channels or building all functionality into every block, two different types of blocks, functional blocks and globals blocks, may be used. Functional blocks may contain a computing circuitry element that includes commonly-used circuit elements that the block uses to carry out computing functions. The functional blocks may not contain other, sparingly or less frequently used circuit elements. Globals blocks can include sparingly or less frequently used circuit elements, which may be shared among a plurality of functional blocks. Individual ones of the functional blocks and the globals blocks can have a same footprint.

In some embodiments, a globals block may be based on a functional block. For example, a globals block may not include most or all of the internal circuitry from a functional block. For example, the globals block may not include a computing circuitry element. At the same time, the globals block can include a functional block's interfaces and communications circuitry. Such interfaces and communications circuitry can be located around or near one or more of the edges of both the globals block and a functional block. In some cases, this may allow a globals block to be swapped directly in place of a functional block in an array. Because the globals block shares the same interfaces as the functional blocks, the globals block and functional blocks can seamlessly interface without changes to the functional block.

In some embodiments, the globals blocks may take up significantly less additional area compared to using channels that include the elements in the globals blocks (e.g., as shown in FIG. 1B). In certain applications, using globals blocks can reduce the area used by an amount in a range from around 2% to around 5% relative to using channels with similar functionality. For example, rather than running the entire length or width of an array as in a traditional channel or grout solution (e.g., as shown in FIG. 1B), globals blocks can be distributed discontinuously throughout the array as desired, thereby reducing the area taken up by sparingly-used elements.

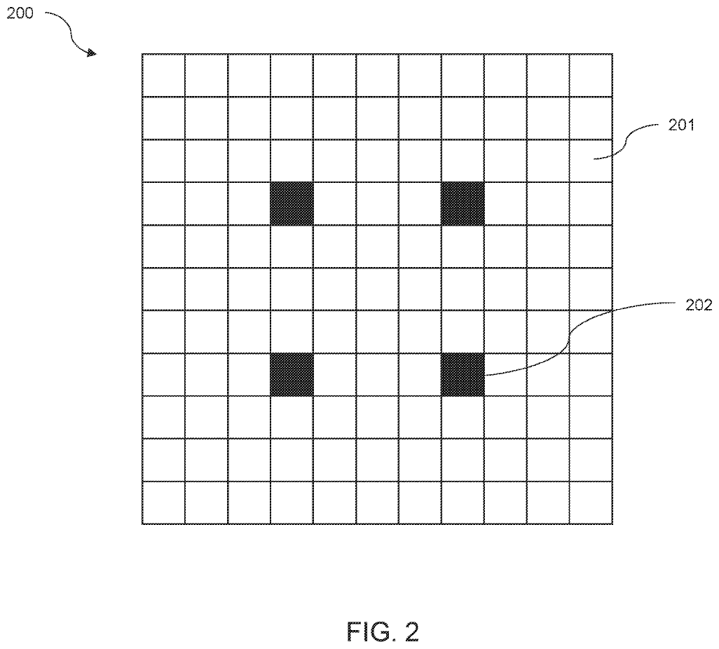

FIG. 2 depicts an array with functional blocks and globals blocks according to certain embodiments. In FIG. 2, an array 200 includes a plurality of functional blocks 201 (illustrated as white blocks) and globals blocks 202 (illustrated as black blocks) which are connected via signal lines within the shown blocks. As illustrated, the array 200 can be a 2-dimensional array. Each block of the array 200 can have the same footprint. Each of the functional blocks 201 is an instance of a computing circuitry block. The globals blocks 202 can each be an instance of a shared block that includes functionality that is shared among more than one functional block 201 and/or not as frequently used as the functional blocks 201. In the array 200, a globals block 202 includes the circuitry of the shared block that is implemented in a same footprint as one functional block 201. With each block of the array 200 having the same footprint, a globals block 202 can be implemented in place of a functional block 201 without impacting the size of the array 200 or spacing between the blocks of the array 200. The array shown in FIG. 2 can be implemented in systems manufactured using a wide range of techniques, for example in a system-on-wafer system, arrays of chips on a printed circuit board, cabinets of systems in a system array, or the like. In certain applications, the array of FIG. 2 can be implemented on a system on a wafer that is packed with a wafer level packaging structure.

The globals blocks 202 may be implemented throughout the array 200 as desired. The globals blocks 202 can be arranged in a periodic pattern, randomly distributed, or distributed according to any other suitable arrangement. In the array 200, there are four globals blocks 202. Any suitable number of globals blocks 202 can be implemented for a particular application. There can be relatively few globals blocks 202 relative to functional blocks 201. For example, the globals blocks 202 can be fewer than 25%, fewer than 20%, fewer than 15%, fewer than 10%, or fewer than 5% of the blocks of the array 200. The signal lines may function as connections between blocks in the array 200 and/or to circuitry external to the array 200.

Each of the functional blocks 201 can implement an instance of computing circuitry arranged to provide specific functionality. For example, a functional block 201 can implement one or more of the following functions: computation, memory/storage, within-die communication, input/output (I/O), analog functions, power regulation, power conversion, and the like. As illustrated, the globals block 202 has the same footprint as a functional block 201. The globals block 202 can fit within a footprint for a functional block. Accordingly, a globals block 202 can be included in place of a functional block in the array without causing the array to be larger. Circuitry of the globals block 202 may not consume all area of the same footprint as a functional block 201, although such a globals block 202 can be considered to have the same footprint as the function block 201 when it generally occupies the space of one functional block in the array 200. The globals block 202 can have an interface and associated circuitry that are the same as or similar to the functional blocks 201. This can allow for ease of connection of the globals block 202 with one or more functional blocks 201 and/or circuitry external to the array 200. The globals block 202 can include one or more of: sensor(s), mask alignment target(s), clock generation and distribution circuitry, non-volatile storage, input/output circuitry, and debug logic. The globals blocks 202 can be implemented in accordance with any suitable principles and advantages of the globals block disclosed herein.

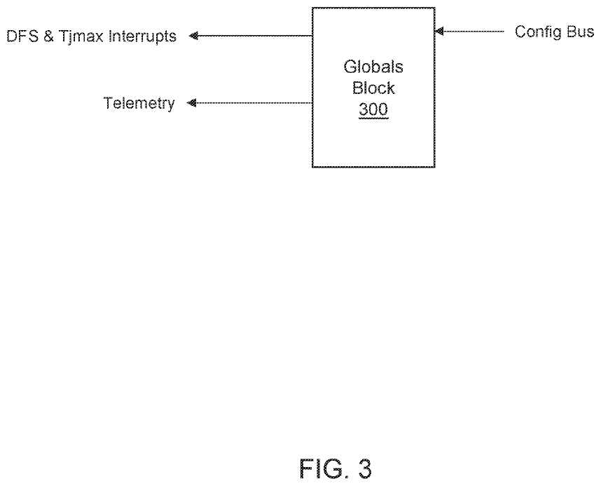

FIG. 3 depicts a schematic block diagram of an illustrative globals block 300. The globals block 300 is an example of the globals block 202 of FIG. 2. The globals block 300 can include one or more sensors (e.g., temperature sensors, voltage sensors, aging sensors, supply noise sensors, process monitors, physical security sensors, etc.). The globals block 300 can include circuitry for implementing power management features, such as dynamic frequency scaling (DFS), dynamic voltage scaling, temperature junction (TJₘₐₓ) interrupts, the like, or any suitable combination thereof. The globals block 300 can communicate (e.g., with functional blocks) over a configuration bus. The configuration bus can carry, for example, address, data, and/or control signals (e.g., “read” and “write”). Configuration functions can be initiated by hardware and/or software. The configuration bus can be used to configure, initiate, and/or check the status of various features and/or operation modes for a block. For example, the configuration bus can be used to set the frequency of a block's phase-locked loop, to initiate calibration of a temperature sensor, and so forth. In certain applications, the globals block 300 can be electrically connected to at least two functional blocks. In some applications, the globals block 300 can be electrically connected to at least four functional blocks. The globals block 300 can provide a telemetry output that is indicative of one or more sensor readings or other information about the globals block and/or one or more functional blocks. The globals block 300 can provide one or more interrupts for a functional block, such as a functional block 201 of FIG. 2.

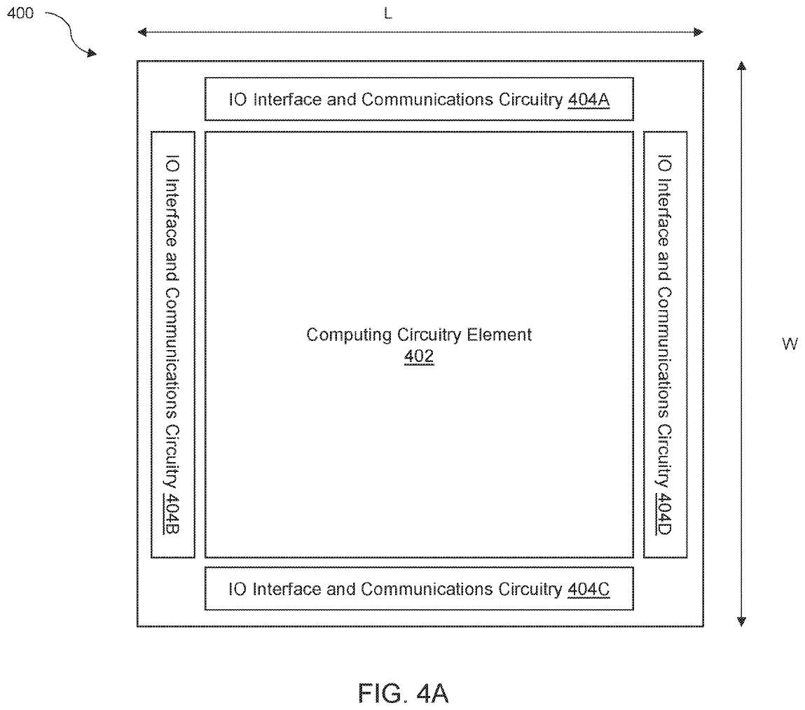

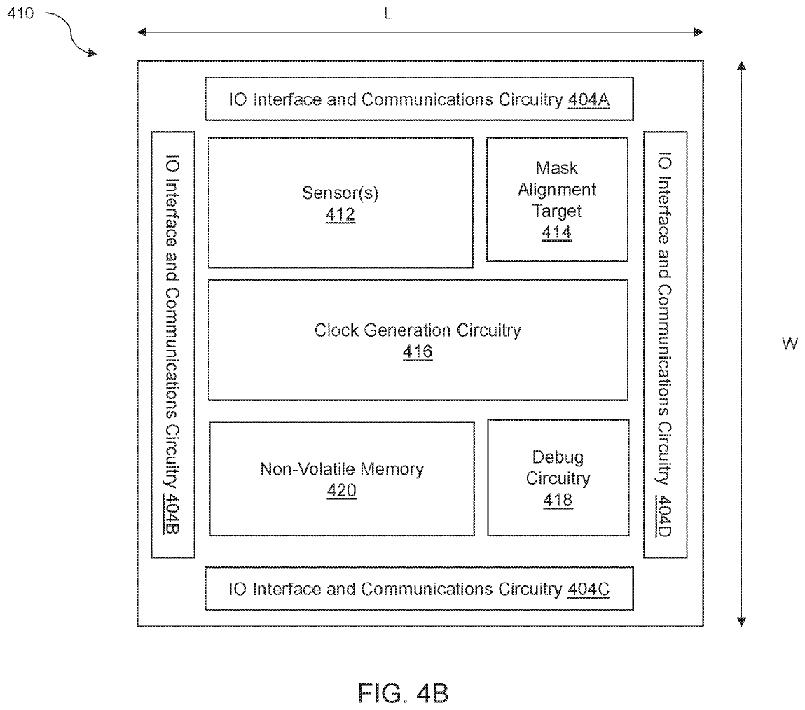

FIGS. 4A and 4B illustrate examples embodiments of a functional block 400 and a globals block 410, respectively. The functional block 400 and the globals block 410 have the same footprint (i.e., the same width W and the same length L). The functional block 400 and the globals block 410 each have IO interface and communications circuitry 404A-404D along the edges of the block. Thus, the functional block 400 and the globals block 410 can provide the same interfaces and communications. The functional block 400 includes a computing circuitry element 402 for carrying out computation tasks. The globals block 410 includes one or more sensors 412, a mask alignment target 414, clock generation circuitry 416, debug circuitry 418, and non-volatile memory 420. Some globals blocks may not have all of the features shown in the globals block 410. For example, some globals blocks may not have non-volatile memory, clock generation and distribution circuitry, and so forth.

The block arrays disclosed herein can be implemented in a processing system with a relatively high compute density. In some instances, such a processing system can execute trillions of operations per second. The processing system can be used in and/or specifically configured for high performance computing and/or computationally intensive applications, such as neural network training, machine learning, artificial intelligence, or the like. The processing system can implement redundancy. In some applications, the processing system can be used to perform neural network training an autopilot system for a vehicle (e.g., an automobile), other autonomous vehicle functionality, or Advanced Driving Assistance System (ADAS) functionality. In some embodiments, the functional block may be suited to general purpose computing, may be configured to perform certain tasks in an optimized manner (e.g., with dedicated circuitry for performing certain tasks), or any combination thereof.

In some embodiments, a system can be configured to provide configuration information from a functional block to a globals block. In some embodiments, a globals block can be configured to provide one or more signals to a functional block. Signals can be, for example, information that the functional block can use to make decisions (e.g., a temperature indication that the functional block can use to determine whether or not to reduce an operating frequency and/or operating voltage). In some embodiments, the globals block can provide a signal that directs the functional block's behavior and/or functionality. For example, in some embodiments, a globals block can measure temperature or an indication of temperature (e.g., a thermocouple voltage) and, based on the measured value, provide a signal to the functional block directing it to adjust one or more operating parameters, such as an operating frequency and/or operating voltage. In some embodiments, the globals block can include any suitable type of digital or analog circuit function. The globals block may be particularly suited to functions that are used in relatively small numbers, or which control and/or interact with a large number of functional blocks. Examples of such functions include without limitation a large sensor with a specialized power supply or a centralized clock signal generator with an output signal that can be used by multiple blocks. In some embodiments, a globals block can include structures used in semiconductor device manufacturing. For example, the globals block can include alignment targets, test structures, and so forth that may be distributed geographically across a device.

The systems disclosed herein can perform a variety of different methods using a globals block. For example, the globals block can measure a parameter. The parameter can be temperature, voltage, clock frequency, or the like. The globals block can generate a signal based on the parameter. The globals block can provide the signal to one or more functional blocks of an array that includes the globals block and a plurality of functional blocks.

In the foregoing specification, the systems and processes have been described with reference to specific embodiments thereof. It will, however, be evident that various modifications and changes may be made thereto without departing from the broader spirit and scope of the embodiments disclosed herein. The specification and drawings are, accordingly, to be regarded in an illustrative rather than restrictive sense.

Indeed, although the systems and processes have been disclosed in the context of certain embodiments and examples, it will be understood by those skilled in the art that the various embodiments of the systems and processes extend beyond the specifically disclosed embodiments to other alternative embodiments and/or uses of the systems and processes and obvious modifications and equivalents thereof. In addition, while several variations of the embodiments of the systems and processes have been shown and described in detail, other modifications, which are within the scope of this disclosure, will be readily apparent to those of skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes of the embodiments of the disclosed systems and processes. Any methods disclosed herein need not be performed in the order recited. Thus, it is intended that the scope of the systems and processes herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and sub-combinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination. No single feature or group of features is necessary or indispensable to each and every embodiment.

It will also be appreciated that conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the embodiments are not to be limited to the particular forms or methods disclosed, but, to the contrary, the embodiments are to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (for example, as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (for example, as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

1. A computing system comprising:
a plurality of functional blocks, wherein each of the plurality of functional blocks is an instance of a computing circuitry block; and
a globals block having a same footprint as an individual one of the functional blocks, the globals block comprising circuitry that is different than the functional block, wherein the plurality of functional blocks and the globals block are included in an array, and wherein the globals block is surrounded by functional blocks of the plurality of functional blocks in the array.

2. The computing system of claim 1, wherein the array comprises a plurality of globals blocks, and the globals blocks comprise the globals block.

3. (canceled)

4. (canceled)

5. The computing system of claim 2, wherein the globals blocks are fewer than 5% of a total number of the functional and globals blocks of the array.

6. The computing system of claim 1, wherein the globals block comprises a sensor configured to sense at least one of temperature or voltage.

7. (canceled)

8. The computing system of claim 1, wherein the globals block is configured to provide an interrupt to at least one of the plurality of functional blocks.

9. The computing system of claim 1, wherein the globals block has a same interface as an individual functional block of the plurality of functional blocks.

10. The computing system of claim 1, wherein the globals block is electrically connected to at least two of the plurality of functional blocks.

11. The computing system of claim 1, wherein the globals block is configured to provide a dynamic frequency scaling signal to at least one functional block of the plurality of functional blocks.

12. The computing system of claim 1, wherein the globals block comprises a mask alignment target.

13. The computing system of claim 1, wherein the globals block comprises clock generation and distribution circuitry.

14. The computing system of claim 1, wherein the globals block comprises debug circuitry.

15. The computing system of claim 1, wherein the globals block comprises non-volatile memory.

16. The computing system of claim 1, wherein the globals block comprises input/output circuitry, and the input/output circuitry is configured to communicate with circuitry that is outside the array.

17. The computing system of claim 1, wherein each of the functional blocks of the plurality of functional blocks comprises an interface along each edge and computing circuitry, and wherein each of the plurality of functional blocks is electrically connected to at least two adjacent functional blocks of the plurality of functional blocks.

18. (canceled)

19. The computing system of claim 1, wherein a system on a wafer includes the array.

20. The computing system of claim 1, wherein the computing system is configured to perform neural network training.

21. A method of operating a computing system, the method comprising:
measuring, by a globals block, a parameter;
generating, by the globals block, a signal based on the parameter; and
providing, by the globals block, the signal to a functional block of a plurality of functional blocks,
wherein the globals block and the plurality of functional blocks are in an array, and wherein the globals block comprises circuitry that is different than the functional block.

22. The method of claim 21, wherein the parameter is temperature or an indication of temperature, and wherein the signal comprises a dynamic frequency scaling signal.

23. The method of claim 21, wherein the parameter is provided by clock generation circuitry, and wherein the signal is a clock signal.

24. The method of claim 21, further comprising providing the signal to a second functional block of the plurality of functional blocks.

25. A computing system comprising:
a plurality of functional blocks, wherein each of the plurality of functionals blocks comprises an instance of a computing circuitry element; and
a globals block having a same footprint as an individual one of the functional blocks, the globals block comprising circuitry that is different than the functional block, wherein the plurality of functional blocks and the globals block are included in an array,
wherein the globals block has a same interface as the individual one of the functional blocks, and
wherein the globals block comprises a sensor configured to sense at least one of temperature or voltage.
